(19) United States
(12) Patent Application Publication
(10) Pub. No.: US 2020/0068943 A1
(43) Pub. Date: Mar. 5, 2020

(54) METHOD FOR PRODUCING A CHEESE SPIRAL AND ASSOCIATED WINDING DEVICE

(71) Applicant: BEL, SURESNES (FR)

(72) Inventors: Dominique QUESTE, LESIGNY (FR); Juan GODOY, SURESNES (FR)

(21) Appl. No.: 16/494,277

(22) PCT Filed: Mar. 15, 2019
(86) PCT No.: PCT/EP2018/056582

§ 371 Date: Sep. 13, 2019

(30) Foreign Application Priority Data
Mar. 15, 2017 (FR) 17 52105

(51) Int. Cl. A23P 30/20; A01J 25/15

(52) U.S. Cl. CPC A23P 30/20; A23C 2250/10; A01J 25/15

(57) ABSTRACT

A method for producing a cheese spiral by supplying a cheese paste, extruding the cheese paste, so as to form a cheese string, and winding of the cheese string upon itself, so as to form the cheese spiral, and a winding device for such a production.

### PRIORITY AND CROSS REFERENCE TO RELATED APPLICATIONS

This application is the U.S. National Phase Application under 35 U.S.C. § 371 of International Application No. PCT/EP2018/056582, filed Mar. 15, 2018, designating the U.S. and published as WO 2018/167229 A1 on Sep. 20, 2018, which claims the benefit of French Application No. FR 17 52105, filed Mar. 15, 2017. Any and all applications for which a foreign or a domestic priority is claimed is/are identified in the Application Data Sheet filed herewith and is/are hereby incorporated by reference in their entireties under 37 C.F.R. § 1.57.

### FIELD

The present invention relates to cheese spirals.

### SUMMARY

The present invention relates to a method for producing a cheese spiral.

### BRIEF DESCRIPTION OF THE DRAWINGS

The characteristics and advantages of the invention will become apparent upon reading the following description, made with reference to the appended drawings, wherein:

FIG. 1 shows a schematic view, from above, of a production facility suitable for implementing a method according to the invention,

FIG. 2 shows a top view of a winding station of the production plant of FIG. 1, some parts of the winding station having been omitted,

FIG. 3 shows a perspective view, three-quarters rear, of the winding station of FIG. 2,

FIG. 4 shows a perspective view, three-quarters front, of the winding station of FIG. 2,

FIG. 5 shows a schematic view in longitudinal section of the winding station of FIG. 2 along a marked V-V plane, and

FIG. 6 shows a block diagram illustrating the steps of a method implemented by the production facility of FIG. 1.

### DETAILED DESCRIPTION

The present invention relates to a method for producing a cheese spiral, i.e. a cheese having a spiral shape.

There are cheese spirals existing under the name of Parenisky. These cheese spirals are traditionally obtained by flattening a cheese paste in order to give it an elongated ribbon shape, this ribbon then being wound upon itself.

Such a method is, however, hardly compatible with the speed required for large-scale industrial production. In addition, such a method allows only obtaining cheese spirals having a very specific form, and, in particular, does not allow the production of cheese spirals having the appearance of a licorice coil.

An object of the invention is thus to allow the production of cheese spirals at rates compatible with large-scale industrial requirements. Other objectives are to allow the production of cheese spirals having the appearance of a licorice roll, the cheese spirals being preferably regular, aesthetic and identical to each other, and to allow appropriate handling of the cheese spiral after its winding as well as easy unwinding of the latter at the moment of its consumption.

For this purpose, the object of the invention is a method for producing a cheese spiral comprising the following steps:
providing a cheese paste,
extruding the cheese paste, in order to form a cheese string, and
winding the cheese string upon itself, in order to form the cheese spiral.

According to particular embodiments of the invention, the production method also has one or more of the following characteristics, considered alone or according to any technically feasible combination(s):
the method comprises an additional step of passing the cheese string through a presser, by means of which the cheese string, which is elongated in a longitudinal direction, is driven in the longitudinal direction and comminuted in a transverse direction substantially perpendicular to the longitudinal direction, wherein the winding comprises the following substeps:
   gripping of an initial end of the cheese string by an gripping member at the outlet of the presser, then
   rotation of the gripping member about an axis of rotation that is substantially perpendicular to the longitudinal and transverse directions;
the step of rotation comprises the simultaneous displacement of the gripping member, together with the axis of rotation, away from the presser;
the displacement of the gripping member together with the axis of rotation is performed in a direction of movement in a plane defined by the transverse and longitudinal directions, the direction of movement being, in particular, constituted by the longitudinal direction;
the gripping member is centered on the axis of rotation;
the axis of rotation is substantially vertical;
the winding step comprises detecting the output of the initial end of the string out of the presser, the rotation of the gripping member being engaged after a predetermined time following this detection;
during its passage through the presser, the cheese string passes through a longitudinal passage defined by the pressure, the passage featuring a constriction having a transverse width of between 3 and 5 mm;
the gripping member is in the form of two claws which, before the rotation of the gripping member begins, are substantially transversely aligned with one another and are transversely spaced apart from one another by a width between 100% and 300% of the transverse width of the constriction;
the presser comprises first and second closed belts defining between them the passage of the cheese string, each of the closed belts being stretched between two pulleys substantially parallel to the axis of rotation and spaced longitudinally apart from each other, each of the closed belts comprising a guidance section, arranged between the pulleys and extending substantially longitudinally, wherein the guidance section of each closed belt faces the guidance section of the other closed belt, the constriction of the passage being constituted by the portion of the passage extending between the guidance sections;
the presser comprises, at the inlet of the passage, an incoming guidance device for adjusting the positioning of the cheese string in the passage in a direction perpendicular to the plane defined by the longitudinal and transverse directions;
the cheese string is received on a support at its outlet from the presser;
the presser comprises, at its outlet, an outgoing guidance member for pressing the cheese string against the support;
the winding step comprises an additional substep of retracting the gripper member inside the support;
the winding step comprises an additional substep of detecting the output of a terminal end of the cheese string from the presser, the retraction of the gripping member inside the support being engaged at the end following a predetermined period after this detection;
the displacement of the gripping member and the axis of rotation consists of a longitudinal translation;
the cheese string is held taut between the outlet of the presser and the gripping member during movement of the gripping member;
the cheese string comprises fibers, a majority of the fibers being oriented in a direction of elongation of the cheese string; and
during winding, the cheese string is at a temperature above 35° C.

The invention also relates to a winding device for winding a spiral cheese string, the winding device comprising:
a frame,
a presser capable of driving the cheese string in a longitudinal direction relative to the frame while compressing the cheese string in a transverse direction substantially perpendicular to the longitudinal direction, the presser having an outlet, and
a gripping member for the cheese string output from the presser, the gripping member being mounted to rotate relative to the frame about an axis of rotation substantially perpendicular to the transverse and longitudinal directions.

According to particular embodiments of the invention, the winding device also has one or more of the following characteristics, considered alone or according to any technically feasible combination(s):
the gripping member is displaceable together with the axis of rotation relative to the frame, between an engaged position, in which the gripping member is close to the outlet of the presser, and a disengaged position, in which the gripping member is at a distance from the outlet of the presser,
the gripping member is displaceable together with the axis of rotation in a direction of displacement in a plane defined by the transverse and longitudinal directions, the displacement direction being, in particular, constituted by the longitudinal direction, and
the axis of rotation is substantially vertical.

Other characteristics and advantages will become apparent upon reading the following description, made with reference to the appended drawings, wherein:

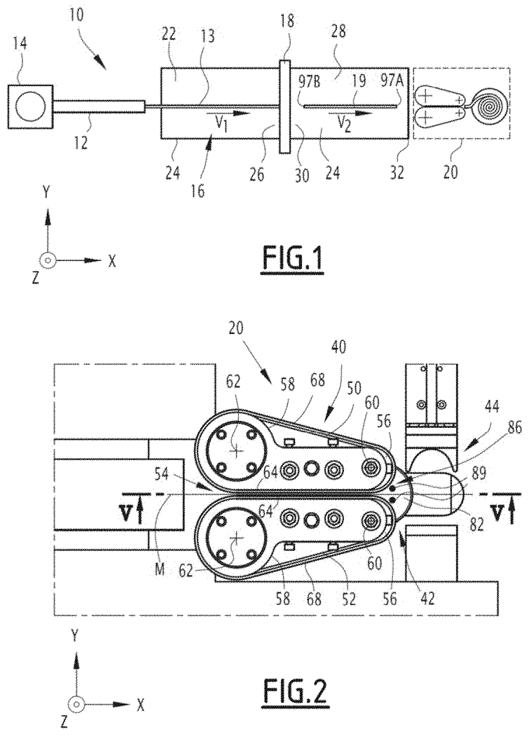

FIG. 1 shows a schematic view, from above, of a production facility suitable for implementing a method according to the invention,

FIG. 2 shows a top view of a winding station of the production plant of FIG. 1, some parts of the winding station having been omitted,

FIG. 3 shows a perspective view, three-quarters rear, of the winding station of FIG. 2,

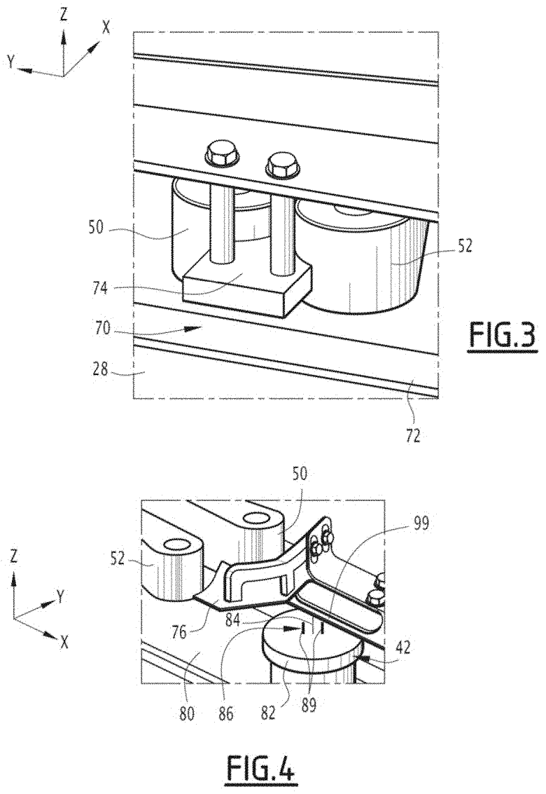

FIG. 4 shows a perspective view, three-quarters front, of the winding station of FIG. 2,

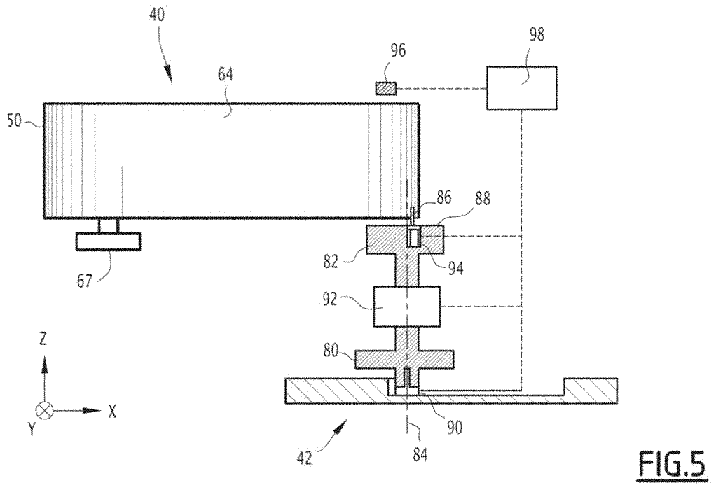

FIG. 5 shows a schematic view in longitudinal section of the winding station of FIG. 2 along a marked V-V plane, and

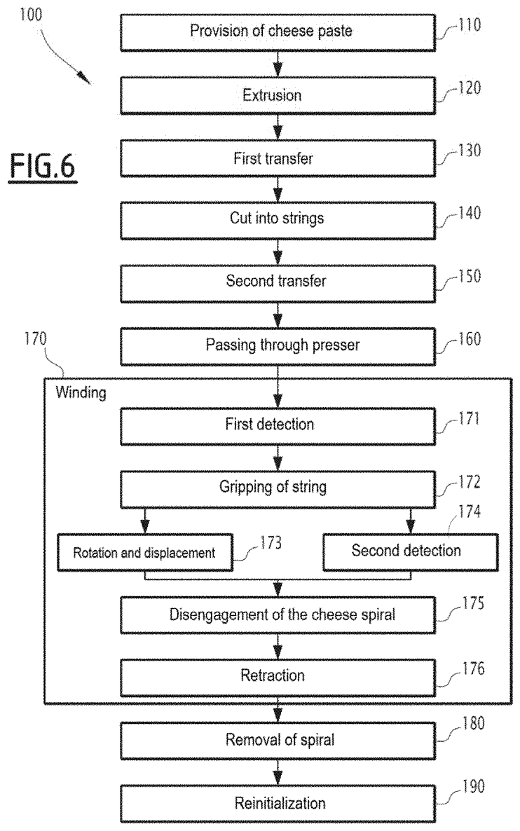

FIG. 6 shows a block diagram illustrating the steps of a method implemented by the production facility of FIG. 1.

In the following, the terms of orientation are to be understood with reference to the usual orthogonal reference of the production lines, shown in the figures, wherein this reference comprises:
a longitudinal direction X, oriented from upstream to downstream,
a transverse direction Y, oriented from right to left and defining with the direction X, a horizontal plane, and
a vertical direction Z.

The production plant 10, shown in FIG. 1, comprises a frame (not shown), an extruder 12, designed to form a cheese string 13 from a cheese paste, a feeding member 14 of the cheese paste extruder 12, a station 16 for the transfer of the cheese string 13 at its outlet from the extruder 12, a station 18 for cutting the cheese string 13 into cheese strings 19, and a station 20 for winding the cheese strings 19 into cheese spirals.

“Cheese paste” is understood to mean here and in the following any product obtained by coagulation, fermented or not, refined or not, mainly obtained from materials of dairy origin, which may include raw materials of plant origin, for example vegetable fat, and water. A cheese paste within the meaning of the present application may, however, contain in small amounts, coagulating agent, manufacturing auxiliary(ies), flavor(s), dye(s), preservative(s), but is preferably free of texturants, emulsifying salts and acidity correctors.

The extruder 12 comprises, in a known manner, a sheath (not shown), oriented in the longitudinal direction, a die (not shown), defining at least one extrusion orifice and closing the sheath at one of its longitudinal ends, and a pushing member (not shown) for pushing the cheese paste contained in the sheath towards the die. The extruder 12 is designed to retain the free-running character of the cheese paste with which it is fed, when the cheese paste is a free-running paste, while directing a majority of the fibers of the free-running paste in the longitudinal direction during the extruding of the free-running paste through the extruder 12.

The diameter of the, or each, extrusion orifice is preferably less than 10 mm and advantageously between 8.5 and 9.5 mm.

“Free-running paste” is understood to mean here and hereinafter a cheese paste having a free-running appearance, i.e. so that, when the paste is handled, it stretches plastically to form a multi-directional filamentary paste.

It is known to extrude a free-running paste through an extruder by orienting all the fibers of the free-running paste in the direction of the sheath. For this purpose, it suffices to play on parameters such as the pushing speed or the extrusion temperature, these parameters being strongly dependent on the characteristics of the paste used, for example the fat content of the latter. Therefore, the settings of the extruder 12 for extruding the free-running paste by orienting all the fibers of the free-running paste in the direction of the sheath, will not be described here.

The feeding member 14 is designed to feed the sheath of the extruder 12 with the cheese paste supplied to it.

The transfer station 16 is designed to transfer the cheese string, from its outlet of the extruder 12, to the winding station 20. For this purpose, the transfer station 16 comprises, in the example shown, a first drive belt 22 extending from an upstream end 24 near the outlet of the extruder 12 to a downstream end 26 near an inlet of the cutting station 18, and a second conveyor belt drive 28 extending from an upstream end 30 near an outlet of the cutting station 18 to a downstream end 32 near an inlet of the winding station 20.

In a known manner, each of the drive belts 22, 28 is constituted by an endless conveyor belt stretched by cylinders (not shown) each oriented transversely and spaced longitudinally from one another, one of these cylinders being disposed at the upstream end 24, 30 of the drive belt 22, 28 and the other cylinder being disposed at the downstream end 26, 32 of the drive belt 22, 28. A portion of the drive belt 22, 28, disposed above the cylinders, defines an upper face of the belt 22, 28.

One of these cylinders is driven by a motor (not shown), in order to drive the belt 22, 28 so that each point of the upper surface moves from the upstream end 24, 30 to the downstream end 26, 32. For each of the drive belts, respectively 22, 28, a speed, respectively V₁, V₂, of the drive belt 22, 28 is defined as the speed of each of these points relative to the frame. The speed V₁, V₂ of each belt 22, 28 is thus oriented substantially longitudinally, from upstream to downstream.

The speed V₂ is preferably greater than the speed V₁. In particular, the speed V₂ is preferably between 10 and 25 m/min, preferably between 15 and 20 m/min.

The cutting station 18 is designed to cut a cross-section of the cheese string 13. For this purpose, the cutting station 18 typically comprises a guillotine (not shown) oriented transversely.

Referring to FIG. 2, the winding station 20 comprises a presser 40 and a winder 42. In the example shown, the winding station 20 further comprises a member 44 for disengaging the cheese spiral.

The presser 40 is designed to drive the cheese strings in the longitudinal direction X while comminuting them in the transverse direction Y. For this purpose, the presser 40 comprises a first and a second closed belt 50, 52 defining between them a passage 54 for the cheese strings 19 and arranged symmetrically with respect to one another relative to a median longitudinal plane M of the presser 40.

Each of the closed belts 50, 52 is mounted stretched between two vertical pulleys 56, 58, i.e. mounted relative to the frame to rotate about substantially vertical axes of rotation 60, 62. These pulleys 56, 58 are spaced longitudinally apart from one another and thus comprises for each closed belt 50, 52, a downstream pulley 56 and an upstream pulley 58, the diameter of the downstream pulley 56 being, in the example shown, less than the diameter of the upstream pulley 58 and being, in particular, substantially equal to half the diameter of the upstream pulley 58. Each of the closed belts 50, 52 comprises a guidance section 64 arranged between the pulleys 56, 58 and positioned opposite the guidance section 64 of the other closed belt 50, 52.

The downstream pulleys 56 are of substantially the same diameter and their axes of rotation 60 are substantially aligned transversely. Similarly, the upstream pulleys 58 are substantially of the same diameter and their axes of rotation 62 are substantially aligned transversely.

The downstream 56 and upstream 58 pulleys of the same closed belt 50, 52 each have a transverse end which is aligned substantially longitudinally with a transverse end of the other pulley 56, 58. For this purpose, the ratio of the distance of the axis of rotation 60 of the downstream pulley 56 to the median longitudinal plane M over the distance from the axis of rotation 62 of the upstream pulley 58 to the median longitudinal plane M, is substantially equal to the ratio of the diameter of the upstream pulley 58 to the diameter of the downstream pulley 56. Thus, both guidance sections 64 of the closed belts 50, 52 extend substantially longitudinally.

The guidance sections 64 thus define between them a constriction 66 of the passage 54, this constriction 66 being constituted by the section of the passage 54 extending between the guidance sections 64. This constriction 66 has a substantially constant cross-section and has a transverse width between 3 and 5 mm, in particular between 3.5 and 4.5 mm. This transverse width is advantageously greater than 30%, preferably greater than 40%, of the diameter of the orifice defined by the die of the extruder 12. The transverse width nevertheless remains less than 60%, preferably less than 50%, of the diameter of the orifice defined by the die of the extruder 12.

The longitudinal length of the constriction 66 is preferably between 150 and 250 mm, preferably between 170 and 190 mm.

For each closed belt 50, 52, one of the pulleys 56, 58 between which the belt 50, 52 is mounted is driven by a motor 67 (FIG. 5). The belt 50, 52 is thus driven so that each point of the guidance section 54 moves from the upstream pulley 58 to the downstream pulley 56 at a speed substantially equal to that of the guidance section 54 of the other belt 50, 52. The speed of the belts 50, 52 is, in particular, substantially equal to the speed V2 of the belt 28.

Each closed belt 50, 52 is preferably made of fabric. It has an outer face 68, facing away from the pulleys 56, 58 between which the belt 50, 52 is mounted. This outer face 68 is advantageously covered with a material compatible with food contact, for example polyurethane.

With reference to FIG. 3, the presser 40 also comprises, at the inlet of the passage 54, an incoming guidance device 70 for correcting the vertical positioning of the cheese strings 19 in the passage 54. This guidance device 70 comprises a lower transverse cylinder 72 and an upper guide plate 74.

The vertical distance between the cylinder 72 and the plate 74 is advantageously between 100 and 150%, preferably between 120 and 130%, of the diameter of the orifice defined by the die of the extruder 12. It is, in particular, adjustable; for this purpose, the vertical position of the guide plate 74 relative to it being preferably adjustable.

The cylinder 72 is mounted to rotate about its axis relative to the frame.

The plate 74 defines a lower face (not shown), facing the axis 72, that is substantially flat.

The cylinder 72 is advantageously made of stainless steel. The plate 74 is preferably made of High Density Polyethylene (HDPE) 500.

With reference to FIG. 4, the presser 40 further comprises, at the outlet of the passageway 54, an outgoing guide member 76 to ensure the correct vertical positioning of the cheese strings with respect to the winder 42. This outgoing guide member 76 is, in particular, designed to press the cheese strings against the winder 42.

For this purpose, the guide member 76 is, in the example shown, constituted by a plate having a substantially flat bottom face (not shown). This plate is typically made of stainless steel.

Referring to FIG. 5, the winder 42 comprises a slider 80, that is mounted to move in translation in the longitudinal direction X relative to the frame, a mandrel 82 mounted to rotate relative to the slider 80 about an axis of rotation 84, and a member 86 for gripping the cheese strings at their outlet from the presser 40.

The slider 80 is movable in translation in the longitudinal direction X between an engaged position, shown in FIGS. 2 and 5, in which the gripping member 86 is placed at the outlet of the presser 40, and a disengaged position, represented in FIG. 4, in which the gripping member 86 is at a distance from the outlet of the presser 40.

The mandrel 82 defines an upper surface 88 for receiving the cheese strings at their outlet from the presser 40. This surface 88 is substantially planar and is also substantially horizontal here.

The surface 88 is, in particular, substantially centered on the axis of rotation 84.

The surface 88 is typically of HDPE 500.

The axis of rotation 84 is substantially parallel to the axes of rotation of the pulleys 60, 62. In the example shown, it is therefore substantially vertical.

Moreover, the axis of rotation 84 is fixed relative to the mandrel 82; in other words, it is immobile with respect to any reference attached to the mandrel 82, regardless of the displacement of the mandrel 82 relative to the other parts of the plant 10 as allowed by the links of the parts of the plant 10 between them. The axis of rotation 84 is also fixed with respect to the slider 80 and with respect to the gripping member 86.

The gripping member 86 is centered on the axis of rotation 84. It is therefore also, in the example shown, centered on the receiving surface 88.

The gripping member 86 is also substantially located in the median longitudinal plane M of the presser 40, i.e. the distance from the center (not shown) of the gripping member 86 to the median longitudinal plane M is less than 1 cm, in particular less than 5 mm.

The gripping member 86 is mounted on the mandrel 82 in order to be rotatable about the axis of rotation 84 together with the mandrel 82. In other words, the gripping member 86 is mounted to rotate about the axis of rotation 84 relative to the mandrel 82.

The gripping member 86 is also mounted to move in translation in the vertical direction Z relative to the mandrel 82 between a retracted position inside the mandrel 82 (not shown), in which the gripping member 86 is below the receiving surface 88, and a deployed position out of the mandrel 82, visible in FIGS. 4 and 5, in which the gripping member 86 protrudes vertically upwards from the receiving surface 88.

The gripping member 86 is in the form of two claws 89 (FIG. 4) each consisting of a substantially vertical rod, typically of stainless steel. When the mandrel 82 is in a starting configuration, visible in FIG. 2, these two claws 89 are substantially transversely aligned with each other and are spaced transversely from each other by a width of between 100% and 300% of the transverse width of the constriction 66.

The center of the gripping member 86 is equidistant from the two claws 89.

The winder 42 also comprises a first drive member 90 for driving the translation of the slider 80 relative to the frame, a second drive member 92 to cause the mandrel 82 to rotate with respect to the slider 80, a third drive member 94 to drive the translation of the gripping member 86 relative to the mandrel 82, a detector 96 for detecting the passage of the initial end 97A and terminal end 97B (FIG. 1) of the cheese strings 19 at the outlet of the presser 40, and a control module 98 for controlling the drive members 90, 92, 94 as a function of the passages detected by the detector 96.

The first drive member 90 is typically constituted by a rotary servomotor driving a linear slider system.

The second drive member 92 is typically constituted by a rotary electric motor.

The third drive member 94 is typically constituted by a pneumatic cylinder.

The detector 96 is typically constituted by a laser sensor.

The control module 98 is typically embodied as an information processing unit comprising a memory storing programs and coupled to a processor for executing the programs. Alternatively, the control module 98 may be made at least partially in the form of programmable logic components, or in the form of dedicated integrated circuits included in the winder 42.

The control module 98 is designed to control the start of the rotation of the mandrel 82 and the translation of the slider 80 towards its disengaged position following a first predetermined period after the detection by the detector 96 of the passage of an initial end 97A of a cheese string. This first predetermined period is between 105 and 120% of the value, expressed in seconds, obtained by the following calculation: D/V_{P}, where D is the longitudinal distance, expressed in meters, between the sensor 96 and the input member 86 when the slider 80 is in its engaged configuration, and V_{P} is the speed, expressed in meters per second, of the belts 50, 52 of the presser 40.

The control module 98 is also designed to control the speed of rotation of the mandrel 82 and the speed of movement of the slider 80 so that each cheese string 19 remains stretched between the gripping member 86 and the presser 40 as the spiral cheese string 19 is wound up.

The control module 98 is further designed to control the stopping of the rotation of the mandrel 82 and the acceleration of the translation of the slider 80 towards its disengaged position after a second predetermined period following the detection by the detector 96 of the passage of a terminal end 97B of a cheese string 19. This second predetermined period is typically substantially equal to the first predetermined period.

The control module 98 is furthermore designed to control the retraction of the gripping member 86 in the mandrel 82 when the slider 80 has reached its disengaged position at the end of a third predetermined period after the detection by the detector 96 of the passage of a terminal end 97B of a cheese string 19.

The control module 98 is finally designed to control the return of the slider 80 to its engaged position, the mandrel 82 to its initial configuration, and the gripping member 86 to its deployed position following a third predetermined period after the slider 80 has reached its disengaged position.

The winder 42 finally comprises a lateral guide 99 (FIG. 4) to fold the terminal ends 97B of the cheese strings 19 against the formed cheese spiral. This lateral guide 99 is, as shown, typically formed by a longitudinally-elongated rod defining a planar face, facing the mandrel 82, arranged at a predetermined distance from the gripping member 86, this predetermined distance being typically between 20 and 30 mm, in particular between 21 and 25 mm.

In the example shown, the disengagement member 44 is formed by a pusher designed to push the cheese spiral out of the mandrel 82 when the slider 80 is in its disengaged position. According to a variant not shown, the disengagement member 44 is in the form of a gripping member.

A method 100 for producing a cheese spiral implemented by the plant 10 will now be described, with reference to FIG. 6.

First, the extruder 12 is fed cheese paste during an initial step 110 of providing the cheese paste.

This cheese paste is, in particular, constituted by a free-running paste.

Advantageously, this cheese paste has been obtained by enzymatic coagulation.

According to a particular embodiment, the cheese paste is a pressed cheese type product. In the context of the present invention, the pressed cheese type product is a pressed cheese product whose WCDC is between 54% and 69%, which corresponds to a semi-hard cheese product according to Codex Standard STAN 283-1978.

Codex Standard STAN 283-1978 proposes a classification of cheese products according to their water content of the degreased cheese product (WCDC). Cheese products with a WCDC between 54% and 69% may be called semi-hard cheese products, and cheese products with a WCDC greater than 67% may be called soft cheese products.

The expression “comprised” is to be understood in a broad sense. Thus, a quantity A lies between a first value A1 and a second value A2 when, on the one hand, the quantity A is greater than or equal to the first value A1 and, on the other hand, the quantity A is smaller than or equal to the second value A2.

Typically, WCDC is calculated as follows: (Weight of water in cheese)×100/(Total weight of cheese−Weight of fat in cheese).

Preferably, the cheese paste used in the method 100 has a solids content of between 47 and 55% by weight relative to the total weight of the cheese paste.

Then, the cheese paste is extruded by the extruder 12 during an extrusion step 120. At the outlet of the extruder 12, a continuous cheese string 13 is thus obtained, elongated in the longitudinal direction X and most of whose fibers are oriented, i.e. more than 70%, and preferably all, i.e. more than 99%, in the direction of elongation of the string 13 and that is easily observable to the eye by manual separation of the hot string 13 at its outlet of the extruder 12, i.e. by pinching two opposite edges of the string 13 and separating them transversely from one another, the string may be split in the direction of its length, it is then that the fibers of the string 13 are oriented in the direction of elongation.

The cheese string 13 is then led by the first drive belt 22, during a first transfer step 130, to the cutting station 18, where it is successively cut into strings 19 of a length between 300 and 400 mm, preferably substantially equal to 350 mm, during a step 140. Cheese strings 19 are then obtained, as may be seen in FIG. 1, each string 19 being elongated in the longitudinal direction X and presenting, according to its direction of elongation, an initial end 97A, constituted by the end of the string 19 positioned the most downstream, and a terminal end 97B, constituted by the end of the string 19 positioned the most upstream.

Each string 19 is then led by the second drive belt 24, during a second transfer step 150, to the winding station 20, where it passes through the presser 40 during a traversing step 160 and is wound upon itself, spirally, during a winding step 170, in order to form the cheese spiral.

During the traversing step 160, the cheese string 19, which arrives oriented in the longitudinal direction X, is first guided by the guidance device 70, which adjusts the vertical position of the cheese string with respect to the belts 50. 52. The cheese string 19 is then supported by the belts 50, 52, which drive this cheese string 19 in the longitudinal direction X.

In doing so, the cheese string 19 advances in the passage 54, until it arrives in the constriction 66. There, the constriction 66 being narrower than the cheese string 19, the cheese string 19 is crushed in the transverse direction Y. As a result, the cross-section of the cheese string 19 takes on an elongated oblong shape in the vertical direction Z .

The cheese string 19 is thus kept crushed to the outlet of the passage 54, where it is received on the receiving surface 88 of the mandrel 82. Due to this crushing, the transverse width of the cheese string 19 at the outlet of the presser 40 is less than 90% of the transverse width of the cheese string 19 at the inlet of the presser 40. However, it remains greater than 40%, preferably greater than 50%, of the transverse width of the cheese string 19 at the inlet of the presser 40.

In particular, the transverse width of the cheese string 19 at the outlet of the presser 40 is typically substantially equal to 4 mm.

It is when the cheese string 19 leaves the presser 40 that the winding step 170 begins.

At the beginning of this winding step 170, the temperature of the cheese string 19 is greater than 35° C. and preferably between 35 and 50° C. Due to the shortness of the winding step 170, it will keep this temperature for substantially the entire duration of the winding step 170. It has, in fact, been surprisingly observed that the use of this temperature during the winding step 170 makes it possible to ensure the cohesion of the turns with respect to each other, without the latter fusing or cracks appearing on the surface of the cheese string 19.

The winding step 170 firstly comprises a first substep 171 of detection by the detector 96 of the output of the initial end 97A of the cheese string 19 out of the presser 40. This detection is typically effective when the detector 96 detects that the laser beam that it emits is cut off.

This sub-step 171 is followed by a substep 172 of gripping the initial end 97A of the cheese string 19 by the gripping member 86 at its outlet from the presser 40. In this substep 172, the slider 80 is in its engaged position, the mandrel 82 is in its starting configuration, and the gripping member 86 is deployed. The cheese string 19 is then engaged between the claws 89 of the gripping member 86. This is easily achieved because the cheese string 19, at its outlet from the presser 40, is included in the median longitudinal plane M of the presser 40, in which plane is also included the gripping member 86. In addition, the receiving surface 88 of the mandrel 82 supports the cheese string 19 from below and thus prevents the cheese string 19 from deflecting downwards relative to the position of the gripping member 86, while the outgoing guidance member 76 flattens the cheese string 19 against this receiving surface 88, thus preventing the cheese string 19 from deflecting upwards relative to the position of the gripping member 86; this avoids the cheese spiral taking the form of a Chinese hat. Finally, the transverse space between the claws 89 is sufficient to allow the passage of the initial end 97A of the cheese string 19 between them.

Since during this sub-step 172, the gripping member 86 is positioned close to the outlet of the presser 40, this prevents the cheese string 19 from deviating transversely with respect to the position of the gripping member 86, and further ensures that the cheese string 19 has retained its oblong cross-section at the moment it is gripped.

Then begins a substep 173 in which the mandrel 82 and the gripping member 86 rotate about the axis of rotation 84 relative to the slider 80, while the slider 80 is translated in the longitudinal direction X away from the presser 40, driving with it the axis of rotation 84, the mandrel 82 and the gripping member 86. This substep 173 is engaged at the end of the first predetermined period after the first detection step 171.

The rotation of the gripping member 86 upon itself allows the cheese string 19 to be wound upon itself and thus to form the cheese spiral.

During this sub-step 173, the speed of rotation of the mandrel 82 and the speed of translation of the slider 80 are regulated in order to keep the cheese string 19 stretched between the outlet of the presser 40 and the gripping member 86, i.e. so that the portion of the cheese string 19 between the presser 40 and the portion of the cheese string 19 already wound extends rectilinearly. For this purpose, the speed of rotation of the mandrel 82 and the speed of translation of the slider 80 are indexed to the speed V_{P} of the belts 50, 52 and to the increase of the circumference of the cheese spiral. This allows the cheese string 19 to be pressed against the cheese spiral and thus ensure a good level of adhesion between the different turns.

During the course of the sub-step 173, the detector 96 detects, during a second detection substep 174, the output of the terminal end 97B of the cheese string 19 from the presser 40. This detection is typically effective when the detector 96 detects the re-establishment of the laser beam that it emits.

At the end of the second predetermined period following this second detection sub-step 174, the cheese spiral is formed. Sub-step 173 then ends, and begins a substep 175 of disengagement of the cheese spiral thus formed.

During this sub-step 175, the rotation of the mandrel 82 and the gripping member 86 relative to the slider 80 is stopped. The translation of the slider 80 to its disengaged position is accelerated.

Then, when the slider 80 has reached its disengaged position, the gripping member 86 is retracted inside the mandrel 82 during a retraction substep 176. This substep 176 is engaged at the end of the third predetermined period after the second detection sub-step 174.

Once the winding step 170 is completed, the cheese spiral is removed from the mandrel 82 by the disengagement member 44 during a retraction step 180.

Then, during a step 190 of reinitializing the winder 42, the slider 80 is returned to the engaged position, the mandrel 82 is returned to its starting position, and the gripping member 86 is redeployed. The winder 42 is then ready to wind a new cheese string 19 coming out of the presser 40.

Thanks to the invention described above, it is thus possible to produce cheese spirals at a high rate and at a lower cost.

In addition, the cheese spirals thus produced may have the appearance of a licorice coil, which was not possible with prior equipment. In fact, to be able to be worked, the cheese products had to be handled in temperature ranges in which they tended to collapse under the effect of their own weight, which prevents fine strings being wrapped around a vertical axis. However, here, by gripping the cheese strings 19 just after their release from the presser 40, one avoids giving them time to expand under the effect of their own weight.

Finally, the cheese spirals thus obtained may be easily unwound at the time of their consumption, in particular thanks to the low adhesion existing between the different turns, and thanks to the orientation of the fibers within each turn.

1.-20. (canceled)

21. A method for producing a cheese spiral, the method comprising the following steps:
providing a cheese paste,
extruding the cheese paste, so as to form a cheese string, and
winding the cheese string upon itself, so as to form the cheese spiral.

22. The method for producing a cheese spiral according to claim 21, comprising an additional step of passage through a presser by the cheese string, during which the cheese string, which is elongated in a longitudinal direction, is driven in this longitudinal direction and crushed in a transverse direction substantially perpendicular to the longitudinal direction, the winding comprising the following substeps:
gripping of an initial end of the cheese string by a gripping member output of the presser, then
rotation of the gripping member about an axis of rotation substantially perpendicular to the longitudinal direction and transverse direction.

23. The method for producing a cheese spiral according to claim 22, wherein the rotating step comprises simultaneously moving the gripping member, together with the axis of rotation, to a distance from the presser.

24. The method for producing a cheese spiral according to claim 22, wherein the displacement of the gripping member together with the axis of rotation is performed in a direction of movement in a plane defined by the transverse direction and longitudinal direction, the displacement direction being, in particular, constituted by the longitudinal direction.

25. The method for producing a cheese spiral according to claim 22, wherein the gripping member is centered on the axis of rotation.

26. The method for producing a cheese spiral according to claim 22, wherein the axis of rotation is substantially vertical.

27. The method for producing a cheese spiral according to claim 22, wherein the winding step comprises detecting the output of the initial end of the string coming out of the presser, the rotation of the gripping member being engaged after a predetermined period after the detection.

28. The method for producing a cheese spiral according to claim 22, wherein, during its passage through the presser, the cheese string follows a longitudinal passage defined by the presser, the passage having a constriction having a transverse width of between 3 and 5 mm.

29. The method for producing a cheese spiral according to claim 28, wherein the gripping member is in the form of two claws which, before the start of the rotation of the gripping member, are substantially transversely aligned with each other and are transversely spaced from each other by a width of between 100% and 300% of the transverse width of the constriction.

30. The method for producing a cheese spiral according to claim 28, wherein the presser comprises a first and a second closed belt defining between them the passage of the cheese string, each of the closed belts being tensioned between two pulleys substantially parallel to the axis of rotation and spaced longitudinally from each other, each of the closed belts comprising a guidance section arranged between the pulleys, extending substantially longitudinally, the guidance section of each closed belt facing the guidance section of the other closed belt, the constriction of the passage being constituted by the portion of the passage extending between the guidance sections.

31. The method for producing a cheese spiral according to claim 28, wherein the presser comprises, at the inlet of the passage, an incoming guidance device for adjusting the positioning the cheese string in the passage in a direction perpendicular to the plane defined by the longitudinal direction and transverse direction.

32. The method for producing a cheese spiral according to claim 21, wherein the cheese string is received on a support at its output of the presser.

33. The method for producing a cheese spiral according to claim 32, wherein the presser comprises, at its output, an outgoing guidance member for pressing the cheese string against the support.

34. The method for producing a cheese spiral according to claim 32, wherein the winding step comprises an additional substep of retracting the gripping member to the inside of the support.

35. The method for producing a cheese spiral according to claim 34, wherein the winding step comprises an additional substep for detecting the output of a terminal end of the cheese string from the presser, the retraction of the gripping member within the support being engaged after a predetermined period after the detection.

36. The method for producing a cheese spiral according to claim 22, wherein the displacement of the gripping member and the axis of rotation consists of a longitudinal translation.

37. The method for producing a cheese spiral according to claim 22, wherein the cheese string is held taut between the outlet of the presser and the gripping member during the movement of the gripping member.

38. The method for producing a cheese spiral according to claim 21, wherein the cheese string comprises fibers, a majority of the fibers being oriented in a direction of elongation of the cheese string.

39. The method for producing a cheese spiral according to claim 21, wherein, during the winding, the cheese string is at a temperature above 35° C.

40. A winding device for winding a spiral cheese string, the winding device comprising:
a frame,
a presser designed to drive the cheese string in a longitudinal direction relative to the frame while compressing the cheese string in a transverse direction substantially perpendicular to the longitudinal direction, the presser having an outlet and a member for gripping the cheese string at the outlet of the presser, the gripping member being mounted to rotate relative to the frame about an axis of rotation that is substantially perpendicular to the transverse and longitudinal directions.
